(19) United States
(12) Patent Application Publication
(10) Pub. No.: US 2010/0236342 A1
(43) Pub. Date: Sep. 23, 2010

(54) Linear actuator

(75) Inventor: Shih-Yuan Tseng, Taichung City (TW)

Correspondence Address: CHARLES E. BAXLEY, ESQUIRE, 90 JOHN STREET, SUITE 309, NEW YORK, NY, 10038, US

(73) Assignee: Hiwin Mikrosystem Corp.

(21) Appl. No.: 12/381,995

(22) Filed: Mar. 18, 2009

(51) Int. Cl. F16H 25/18

(52) U.S. Cl. 74/89

(57) ABSTRACT

A linear actuator is characterized by having an upper sleeve part formed with a fastening portion that has a lower surface including at least one non-arched plane, a lower sleeve part formed with a fastening portion that has an upper surface including at least one non-arched plane so that a sleeve composed of the sleeve parts has an annular fastening section that includes at least the two non-arched planes; a rear fastening head having a combining portion that is fittedly received in the sleeve and is retained from rotating relative to the sleeve; at least one first fixing element provided at a lower surface of the upper sleeve part or an upper surface of the lower sleeve part; and at least one second fixing element provided at a tubular sheathing to face and engage with the first fixing element.

### BACKGROUND OF THE INVENTION

1. Technical Field

The present invention relates to linear actuators. More particularly, the present invention relates to a linear actuator that comprises modulized components and thus has improved structural strength as well as operational advantages.

2. Description of Related Art

Linear actuators are extensively used as an economic and efficient approach to applications where precise positioning control is required. For example, linear actuators service for manageable positioning control in antenna elevator systems, automatic wheelchairs, automatic hospital beds, massage chairs, rehabilitation devices and so on.

In view of the extensive application scope of linear actuators, all related manufacturers invariably pursue enhanced structural strength and improved durability of linear actuators. For achieving this end, the inventor of the present invention has identified the disadvantages of the existing linear actuators.

First, in an existing linear actuator, for providing competent structural strength and preventing the internal components from cracking and breaking under impaction or heavy load, most of the connecting components, such as the fastening head for being coupled with an external object and the sleeve parts inside the gearbox for holding the transmission mechanism are typically made of rigid metal that is durable yet is heavy and expensive. Besides, during operation, the resonance generated between these metal components can significantly increase mechanical noise. The above-recited disadvantages thus bring additional limitation to the application scope of the existing linear actuators.

Besides, in the existing linear actuator, there lacks a dedicated mechanism to couple the upper and lower sleeve parts with the tubular sheathing. Thus, the tubular sheathing tends to sway relative to the sleeve parts during operation, and thus may not only cause impact noises, but also adversely affect the structural stability of the linear actuator. As can be expected, when lying in a hospital bed or operating a rehabilitation device using such an existing liner actuator, a patient is doing nothing more than putting himself/herself in danger and discomfort.

### SUMMARY OF THE INVENTION

In view of the shortcomings of the existing devices, the present invention herein provide an improved linear actuator that comprises modulized components and thus has improved structural strength as well as operational advantages.

The disclosed linear actuator comprises at least an upper sleeve part and a lower sleeve part that jointly compose a sleeve to hold a rear fastening head and a tubular sheathing at two opposite ends thereof, the linear actuator being characterized by:

the upper sleeve part having a first end and a second end, wherein the first end is formed with a fastening portion that has a lower surface including at least one non-arched plane;

the lower sleeve part having a first end and a second end, wherein the first end is formed with a fastening portion that has an upper surface including at least one non-arched plane so that in the sleeve, the fastening portions of the sleeve parts are adjacent each other and form an annular fastening section that includes at least two said non-arched planes;

the rear fastening head having a combining portion that is fittedly received in the annular fastening section of the sleeve and is retained from rotating relative to the annular fastening section;

at least one first fixing element provided at a lower surface of the second end of the upper sleeve part or an upper surface of the second end of the lower sleeve part; and

at least one second fixing element provided at the tubular sheathing that faces and engages with the first fixing element.

Thereby, the advantages of the disclosed linear actuator includes that the combining portion of the rear fastening head is stably positioned by the annular fastening section of the sleeve composed of the upper and lower sleeve parts, and thus the linear actuator is safe in use.

The advantages of the disclosed linear actuator also includes that the at least two non-arched planes structurally retain the rotating, and thus the components are not necessarily made of metal. Consequently, the manufacturing costs, overall weight, and mechanical noise of the linear actuator are significantly reduced from as compared with those of the conventional linear actuator.

### BRIEF DESCRIPTION OF THE DRAWINGS

The invention as well as a preferred mode of use, further objectives and advantages thereof will be best understood by reference to the following detailed description of an illustrative embodiment when read in conjunction with the accompanying drawings, wherein:

FIG. 1 is a perspective view of a linear actuator according to one embodiment of the present invention;

FIG. 2 is an exploded view of the linear actuator of FIG. 1;

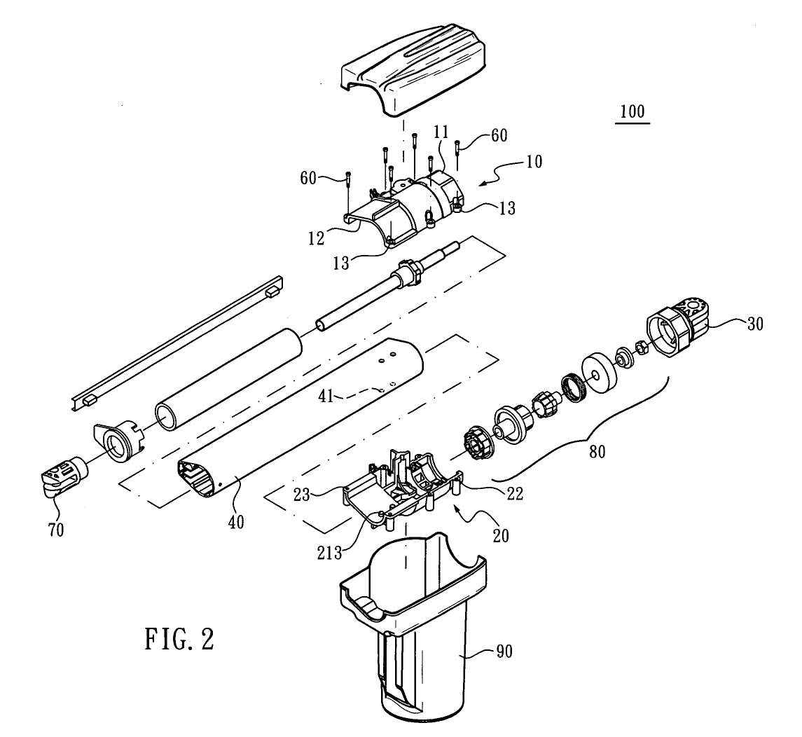

FIG. 3 is an enlarged exploded view illustrating an upper sleeve part, a lower sleeve part, a rear fastening head and a tubular sheathing according to the embodiment of the present invention; and

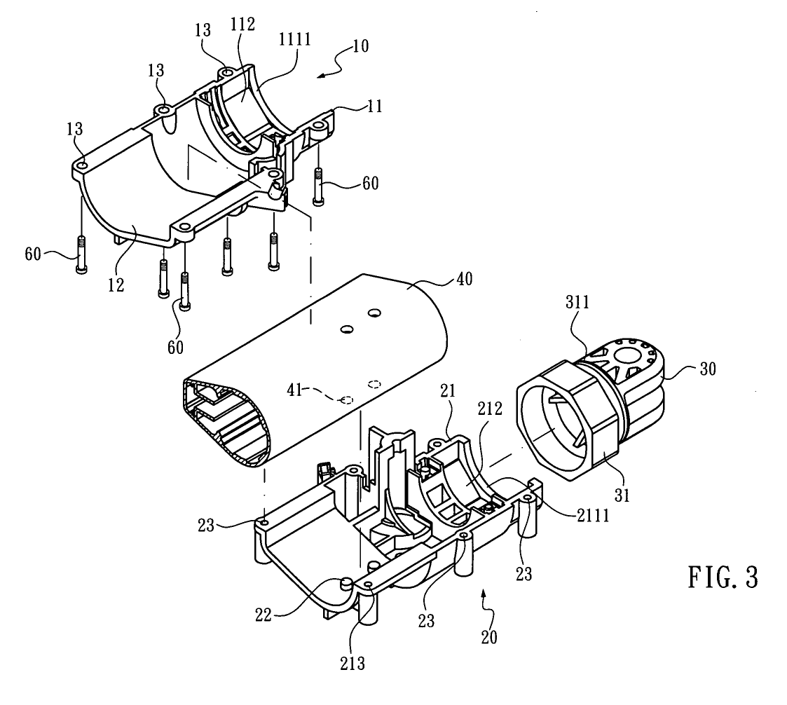

FIG. 4 is a schematic drawing illustrating the assembly of the upper sleeve part, the lower sleeve part, the rear fastening head and the tubular sheathing.

### DETAILED DESCRIPTION OF THE PREFERRED EMBODIMENTS

While the present invention proposes a linear actuator for positioning control, the operational principles thereof are known to one skilled in the art and need not be discussed at any length herein. Meanwhile, the accompanying drawings referred to in the following description are provided for illustrative purposes and need not to be made to scale.

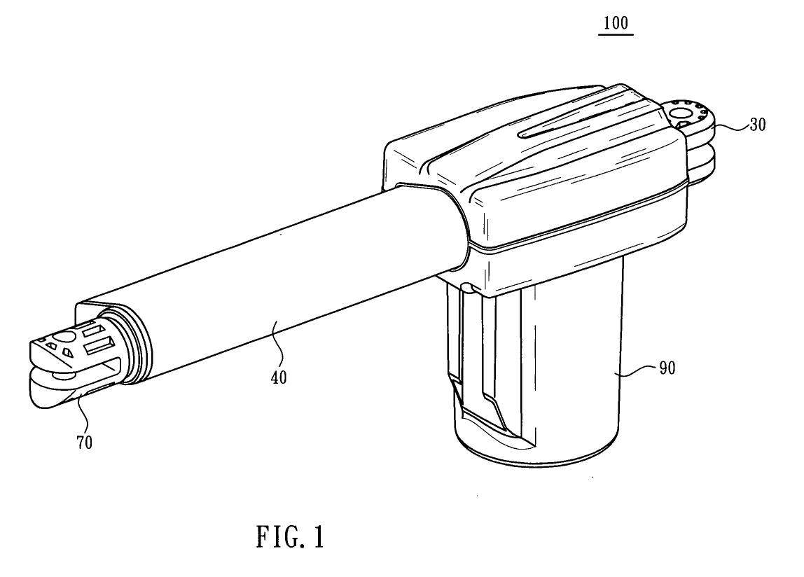

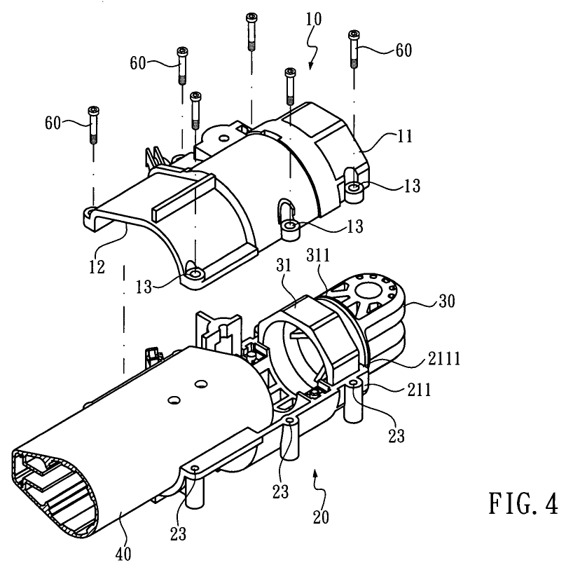

Please refer to FIG. 1 and FIG. 4 for a linear actuator 100 according to one embodiment of the present invention. As can be seen in the drawings, the linear actuator 100 comprises at least an upper sleeve part 10 and a lower sleeve part 20 that jointly compose a sleeve to hold a rear fastening head 30 and a tubular sheathing 40 at two opposite ends thereof. The tubular sheathing 40 serves to accommodate an actuation shaft assembly 80. The actuation shaft assembly 80 has two opposite ends thereof connected with a font pushing head 70 and the rear fastening head 30. As known linear actuators, the rear fastening head 30 of the presently disclosed linear actuator 100 is fixedly bound to an immovable part of an external device (not shown) while the font pushing head 70 is coupled with a movable part of the external device. For example, in a hospital bed, the rear fastening head 30 may be fixedly bound to the immovable bedplate segment while the font pushing head 70 may be coupled with the movable bedplate segment. Thereby, when mechanisms in a gear box 90 drives the actuation shaft assembly 80, the actuation shaft assembly 80 pushes the font pushing head 70 to linearly move, so as to change the position (posture) of the external device.

The present invention particularly brings improvements to the upper sleeve part 10, the lower sleeve part 20, the rear fastening head 30 and the tubular sheathing 40.

The upper sleeve part 10 has a first end 11 and a second end 12. Therein, the first end 11 is formed with a fastening portion 111 that has a lower surface 112 including at least one non-arched plane. Similarly, the lower sleeve part 20 also has a first end 21 and a second end 22. The first end 21 is formed with a fastening portion 211 that has an upper surface 212 including at least one non-arched plane. According to one concept of the present invention, the upper and lower sleeve parts 10, 20 have identical sectional shapes. When the upper and lower sleeve parts 10, 20 are combined to form the sleeve, the first ends 11, 21 and the second ends 12, 22 are combined face to face, so that the fastening portions 111, 211 of the sleeve parts 10, 20 are adjacent to each other and form an annular fastening section that includes at least two said non-arched planes. According to the present embodiment, each of the lower surface 112 of the fastening portion 111 of the upper sleeve part 10 and the upper surface 212 of the fastening portion 211 of the lower sleeve part 20 includes four continuous, non-arched, non-coplanar planes. Thus, the annular fastening section has an octagonal sectional shape while a combining portion 31 of the rear fastening head 30 also has an octagonal sectional shape so as to be fittedly received in the annular fastening section. Besides, the annular fastening section has two opposite ends. At least one said end is formed with a centripetally extended annular flange. For example, raised portion 1111 and 2111 provided on fastening portion 111, 211 of the upper and lower sleeve parts 10, 20 jointly form the centripetally extended annular flange.

In the present embodiment, the combining portion 31 of the rear fastening head 30 is formed with a reduced-diameter segment 311 to abut against the annular flange, so that the rear fastening head 30 is retained from axially shifting relative to the annular fastening section. Therefore, as shown in FIG. 4, when the rear fastening head 30 is positioned between the upper and lower sleeve parts 10, 20, the annular fastening section retains the rear fastening head 30 from rotating and the annular flange retains the rear fastening head 30 from axially shifting.

Furthermore, as can be seen in the drawings, at least one first fixing element, such as a fixed pin 213, is provided at, for example, the upper surface 212 of the second end 22 of the lower sleeve part 20. Meantime, at least one second fixing element, such as a recess 41, is provided at the tubular sheathing 40 for facing and engaging with fixed pin 213.

In addition, threaded holes 13, 23 are provided at the upper sleeve part 10 and the lower sleeve part 20, respectively, for allowing screws 60 to pass therethrough and thus combine the upper and lower sleeve parts 10, 20 firmly.

Accordingly, the disclosed linear actuator 100 is advantageous for the reasons that the combining portion of the rear fastening head is stably positioned by the annular fastening section of the sleeve composed of the upper and lower sleeve parts, and thus the linear actuator is safe in use and the reason that the at least two non-arched planes structurally retain the rotating, and thus the components are not necessarily made of metal. The previously described structure of the linear actuator 100 implements structural designs to enhance the mechanical strength and thus plastic can be used to make the related components. To sum up, the disclosed linear actuator 100 is beneficial for requiring manufacturing costs, reducing overall weight and mechanical noise.

The present invention has been described with reference to the preferred embodiment and it is understood that the embodiment is not intended to limit the scope of the present invention. Moreover, as the contents disclosed herein should be readily understood and can be implemented by a person skilled in the art, all equivalent changes or modifications which do not depart from the concept of the present invention should be encompassed by the appended claims.

What is claimed is:

1. A linear actuator comprises at least an upper sleeve part and a lower sleeve part that jointly compose a sleeve to hold a rear fastening head and a tubular sheathing at two opposite ends thereof, the linear actuator being characterized by:
the upper sleeve part having a first end and a second end, wherein the first end is formed with a fastening portion that has a lower surface including at least one non-arched plane;
the lower sleeve part having a first end and a second end, wherein the first end is formed with a fastening portion that has an upper surface including at least one non-arched plane so that in the sleeve, the fastening portions of the sleeve parts are adjacent to each other and form an annular fastening section that includes at least two said non-arched planes;
the rear fastening head having a combining portion that is fittedly received in the annular fastening section of the sleeve and is retained from rotating relative to the annular fastening section;
at least one first fixing element provided at a lower surface of the second end of the upper sleeve part or an upper surface of the second end of the lower sleeve part; and
at least one second fixing element provided at the tubular sheathing for facing and engages with the first fixing element.

2. The linear actuator of claim 1, wherein each of the lower surface of the fastening portion of the upper sleeve part and the upper surface of the fastening portion of the lower sleeve part includes four continuous, non-arched, non-coplanar planes so that the annular fastening section has an octagonal sectional shape while the combining portion of the rear fastening head also has an octagonal sectional shape so as to be fittedly received in the annular fastening section.

3. The linear actuator of claim 1, wherein the annular fastening section has two opposite ends and at least one said end is formed with a centripetally extended annular flange so that the combining portion of the rear fastening head abuts against the annular flange and is retained from axially shifting relative to the annular fastening section.

4. The linear actuator of claim 1, wherein the first fixing element provided at the lower surface of the second end of the upper sleeve part or the upper surface of the second end of the lower sleeve part is a fixed pin and the least one second fixing element provided at the tubular sheathing to is a recess the fittedly receive the fixed pin.

5. The linear actuator of claim 1, wherein threaded holes are provided at the upper sleeve part and the lower sleeve part, respectively, for allowing screws to pass therethrough and combine the upper and lower sleeve parts.
